(19) United States
(12) Patent Application Publication
(10) Pub. No.: US 2002/0169247 A1
(43) Pub. Date: Nov. 14, 2002

(54) Polyol latex compositions and condensation polymers formed therefrom

(76) Inventors: Thauming Kuo, Kingsport, TN (US); John David Moncier, Church Hill, TN (US); Allan Scott Jones, Wonder Lake, IL (US); David Logan Murray, Fall Branch, TN (US)

Correspondence Address: Michael K. Carrier, Eastman Chemical Company, P.O. Box 511, Kingsport, TN, 37662-5075, US

(21) Appl. No.: 10/094,246

(22) Filed: Mar. 8, 2002

Related U.S. Application Data
(60) Provisional application No. 60/282,603, filed on Apr. 9, 2001.

(51) Int. Cl. C08J 3/02

(52) U.S. Cl. 524/457

(57) ABSTRACT

The present invention relates to polyol latex compositions, to methods of making such compositions, and to condensation polymers comprising such compositions.

### CROSS REFERENCE TO RELATED APPLICATIONS

This application claims benefit of priority under 35 USC §119(e) to U.S. Provisional Application No. 60/282,603 filed on Apr. 9, 2001, the contents of which are incorporated herein by reference.

### FIELD OF THE INVENTION

The present invention relates to polyol latex compositions, to methods of making such compositions, and to condensation polymers comprising such compositions.

### BACKGROUND OF THE INVENTION

Latex polymers are utilized in a variety of products due to the unique features of their delivery system. Latex polymers, by nature, have lower viscosities than their solution counterparts. This lower viscosity allows for higher polymer concentrations to be delivered in an application without encountering the numerous problems associated with high viscosity fluids. The reason for the unique viscosity behavior of latex polymers results from the heterogeneity of the system. The fact that the latex polymers are dispersed, rather than dissolved, in a continuous low viscosity medium reduces the influence of the latex polymer on the viscosity of the media. Therefore, the continuous phase or solvent of the latex is generally the dominant component affecting the viscosity of the system.

Typically, the continuous phase of most commercial latexes is water. This is beneficial because water has low toxicity and is not flammable. Water is therefore a good choice when the continuous phase is to be used as a delivery system for the polymer. In some circumstances, however, water may be detrimental to the substrate, or it may be necessary to change the drying characteristics of the latex.

Solvents other than water may be used in the continuous phase. For example, the addition of diol solvents in minor amounts is known. JP 04335002 discloses the addition of alcohol(s) as an antifreeze agent for the production of vinyl ester emulsions at low temperatures. The amount of the diol solvent disclosed is below 50 wt. %. JP 63186703 discloses the addition of film forming agents and plasticizers in an amount up to 10 wt. % of the solid component to affect film formation properties of the resulting emulsion. JP06184217 discloses the addition of polyols and water-soluble inorganic salts to the product of vinyl chloride suspension aqueous polymerizations to produce vinyl chloride polymers that have good powder fluidity. EP 255137 discloses the use of water soluble alcohol in a water/alcohol level of 100/0 to 50/50 for producing polyvinylester with a high degree of polymerization.

U.S. Pat. No. 3,779,969 describes the use of glycols such as ethylene glycol (ethylene diol), propylene glycol (propylene diol), and diethylene glycol (diethylene diol) in amounts of 10-50 wt % of the emulsion. The glycol is added to impart improved wetting properties to the emulsion.

U.S. Pat. No. 4,458,050 describes a process for the manufacture of polymer dispersions in diols intended as chain extenders. The low viscosity polymer dispersions are then used for the preparation of polyurethanes. The '050 patent does not disclose compositions that result in stabilized latexes in which the continuous phase is one or more diol solvents. The patent discloses the use of large amounts of polymeric stabilizers to produce the dispersion polymer.

JP 60040182 and JP 64001786 disclose compositions for water-oil repellency for fabric treatment. The compositions are directed toward producing fluoropolymer emulsions in a mixture of diol solvents. Such fluoropolymers are not the subject of this invention.

U.S. Pat. No. 4,810,763 discloses suspension polymerization, in an organic medium such as ethylene glycol or glycerol, for the preparation of pressure sensitive adhesives. The compositions described in the '763 patent are large particle size dispersions. This patent does not disclose compositions having a particle size below 1000 nm, nor does the patent disclose emulsion polymerization.

U.S. Pat. Nos. 4,885,350 and 5,061,766 disclose the dispersion polymerization of vinyl monomers in various hydrophilic organic liquids in which the vinyl monomers are soluble but the resulting polymer is substantially insoluble. These dispersion polymers require the use of large amounts of polymeric dispersion stabilizers.

It is known to modify condensation polymers by blending the condensation polymer with another polymer in an extruder. For example, to improve the impact properties of a polyester, a low T_{g} elastomer is typically added to the polyester in a twin-screw extruder. Japan Kokai JP 02155944 describes compounds for moldings comprising physical blends of saturated polyester with polystyrene polymers containing 1-100 phr glycidylamido-grafted olefin polymers of glycidyl methacrylate-graft olefin polymers. Japan Kokai JP 02016145, JP 02024346, JP 01123854, JP 01153249 and JP 01163254 each disclose the blending of aromatic polyesters with resins prepared by graft emulsion copolymerization. In each of these references, the size of the dispersed phase is said to be critical in obtaining good properties. The process described is quite energy intensive, and sometimes results in an undesirable reduction in the physical properties of the polymer, in particular the molecular weight. Further, a blending step is required, which utilizes more resources and more time.

U.S. Pat. Nos. 5,652,306, 4,180,494 and 5,409,967 disclose compositions for impact modified aromatic polyesters involving blending an acrylic or polybutadiene/acrylic rubber powder with polylethylene terephthalate (PET). The acrylic rubber particles are prepared by typical core/shell emulsion polymerization, and are then harvested by spray drying the latex. A procedure for latex harvesting is outlined in U.S. Pat. No. 3,985,703. The extrusion blending of an elastomer and a plastic is labor intensive and time consuming. Typically, polybutadiene or poly(butyl acrylate) is used as the low T_{g} (glass transition temperature) polymer to impact modify the polyester. These low T_{g} elastomers are difficult to handle and require that a second monomer, typically poly(methyl methacrylate), be utilized as a shell surrounding the low T_{g} polymer core, so that the low T_{g} polymer may be handled. The core-shell polymer must be isolated, dried, and then added to the polyester in an extruder.

U.S. Pat. No. 6,197,878 B1, the disclosure of which is incorporated by reference in its entirety, discloses the preparation of latex polymer compositions prepared in a continuous medium comprising diols, or mixtures of diols and polyols. Such latex compositions are usually prepared via emulsion polymerization. U.S. Pat. No. 6,197,878 B1 further discloses the incorporation of these latex compositions into a condensation polymerization reaction, whereby a latex/condensation polymer blend is obtained. However, all formulations in this patent require a diol in the continuous phase of the latex composition.

### SUMMARY OF THE INVENTION

The invention provides polymerized polyol latex compositions in which the composition is essentially free of a diol component. In a further aspect, the invention provides methods of making such polyol latex compositions. The invention also provides a method of making a condensation polymer blend utilizing polyol latex compositions.

Additional advantages of the invention will be set forth in part in the description that follows, and in part will be apparent from the description, or may be learned by practice of the invention. The advantages of the invention will be realized and attained by means of the elements and combinations particularly pointed out in the appended claims. It is to be understood that both the foregoing general description and the following detailed description are exemplary and explanatory only, and are not restrictive of the invention as claimed.

### DETAILED DESCRIPTION OF THE INVENTION

The present invention may be understood more readily by reference to the following detailed description of preferred embodiments of the invention and to the Examples included herein.

Before the present compositions of matter and methods are disclosed and described, it is to be understood that this invention is not limited to specific synthetic methods or to particular formulations, and, as such, may vary from the disclosure. It is also to be understood that the terminology used is for the purpose of describing particular embodiments only, and is not intended to be limiting.

In this specification and in the claims which follow, reference will be made to a number of terms which shall be defined to have the following meanings:

The singular forms a, an, and the include plural referents unless the context clearly dictates otherwise.

Optional or optionally means that the subsequently described event or circumstances may or may not occur. The description includes instances where the event or circumstance occurs and instances where it does not.

Diol is a synonym for glycol or dihydric alcohol. Polyol is a polyhydric alcohol containing three or more hydroxyl groups.

The abbreviation “nm” means nanometers.

Ranges may be expressed as “from about” one particular value, and/or “to about” another particular value. When such a range is expressed, it is to be understood that another embodiment is from the one particular value and/or to the other particular value. Similarly, when values are expressed as approximations, by use of the antecedent “about,” it will be understood that the particular value is another embodiment.

Throughout this application, where publications are referenced, the disclosures of these publications in their entireties are hereby incorporated by reference into this application in order to more fully describe the state of the art to which the invention pertains.

In a first aspect, the invention concerns the preparation of a polyol latex composition by emulsion polymerization, wherein the continuous phase comprises a polyol component and wherein the composition is essentially free of diol. The polyol latex composition may be used for a variety of purposes, including, but not limited to, ink compositions, pigment concentrates, coatings, and as reactants in condensation polymerization processes. The polyol latex composition comprises a latex polymer and a continuous phase, the continuous phase comprising a polyol component. As used herein, the term “polyol latex composition” includes latexes comprised of both core shell and/or non-core shell latex polymers.

The continuous phase of the polyol latex compositions must contain one or more polyol components. Polyol components that may be used in the continuous phase include, but are not limited to, one or more of glycerol, trimethylolpropane, trimethyolethane, pentaerythritol, 1,2,6-hexanetriol, sorbitol, 1,1,4,4-tetrakis(hydroxymethyl)cyclohexane, tris-(2-hydroxyethyl)isocyanurate and dipentaerythritol. In addition to low molecular weight polyols, higher molecular weight polyols (MW 400-3000), such as triols derived by condensing alkylene oxides having from 2 to 3 carbons, e.g., ethylene oxide or propylene oxide, with polyol initiators, having from 3 to 6 carbons, e.g., glycerol, can also be used. In the polyol latex compositions of the present invention, it is critical that the compositions be essentially free of diol. That is, there is no diol in the polyol latex compositions herein. By diol it is meant any aliphatic or cycloaliphatic diol having from about 2 to about 10 carbon atoms, or mixtures thereof. Diols excluded from the polyol latex may also be ethylene diol, 1,3-trimethylene diol, propylene diol, tripropylene diol, 1,4-butanediol, 1,5-pentanediol, 1,6-hexanediol, 1,7-heptanediol, 1,8-octanediol, 1,9-nonanediol, neopentyl diol, cis- or trans-cyclohexanedimethanol, cis- or trans- 2,2,4,4-tetramethyl-1,3-cyclobutanediol, diethylene diol, 2,2,4-trimethyl-1,3-pentanediol, 2-methyl-1,3-propanediol, 2-methyl-1,3-pentanediol, and mixtures thereof.

In one aspect, the polyol component is present in an amount of from greater than 10 to 100 weight %, based on the total weight of the continuous phase; still further from greater than 40 to 100 weight %, based on the total weight of the continuous phase; still further, from greater than 75 to 100 weight %, based on the total weight of the continuous phase; still further, from greater than 90 to 100 weight %, based on the total weight of the continuous phase; and still further, greater than 100 weight %, based on the total weight of this continuous phase. In a further aspect, the polyol containing continuous phase consists essentially of the polyol component. Yet still further, the polyol component may be from greater than 5, 10, 15, 20, 25, 30, 35, 40, 45, 50, 55, 60, 65, 70, 75, 80, 85, 90, 95, 99, or 100 weight %, where any of the recited values may be used as the lower endpoint and vice versa.

In a further aspect, the continuous phase of the polyol latex compositions consists essentially of polyol. In this aspect, it is critical that the polyol is liquid at the temperature at which the latex monomers are polymerized in the continuous phase. As one example of a polyol that is suitable for this aspect of the invention, glycerol may be used. However, any polyol that is liquid at the temperatures used to polymerize the monomers may also be utilized.

In one aspect, the polyol latex compositions of this invention are prepared by emulsion polymerization. The solids content of the emulsion polymerization reaction may be from greater than 5 to 60 weight %, or from 20 to 50 weight %. Still further, the solids content of the reaction may be greater than 1, 5, 10, 15, 20, 25, 30, 35, 40, 45, 50, 55, 60, 65, 70, 75, 80, 85, 90, 95, and 99 weight %, where any of the recited values may be utilized as the upper endpoint and vice versa. The temperature of the reaction may be from 0 to 190° C. or from 60 to 90° C. In one aspect, the polyol latex compositions are not prepared by suspension polymerization.

The continuous phase may also comprise a cosolvent. These cosolvents include, but are not limited to, water, methanol, ethanol, propanol, n-butanol, and mixtures thereof. The cosolvent may be present in the amount of less than 60 weight %, more or less than 40 weight %, or less than 30%, 20%, 10% or 5 weight %, based on the total weight of the continuous phase. The co-solvent may not be a diol. In a further aspect, the polyol latex composition is essentially free of a water soluble organic salt.

As used herein, the total weight of the continuous phase includes the weight of the polyol component and co-solvent, if any. The weight of any stabilizer is not included in the total weight of the continuous phase.

The polyol latex compositions can include one or more stabilizers wherein the stabilizer is either a surfactant or a sulfopolyester.

When the stabilizer is a surfactant, the amount of surfactant utilized may vary. In specific aspects, the surfactant may be present at from 0.1 to 10 weight %. Still further, the amount of surfactant may be from 0.1 to 10 weight %, or from 1.0% to 5.0 weight %. Still further, the amount of surfactant may be from 0.5, 1.0, 1.5, 2.0, 2.5, 3.0, 3.5, 4.0, 4.5 or 5.0 weight %, where any of the recited values may be utilized with any endpoint and vice versa.

One of ordinary skill in the art would recognize that the type and amount of surfactant used in the emulsion polymerization depends on the monomer combinations and the polymerization conditions. Surfactants used in the emulsion polymerization may be anionic, cationic or nonionic surfactants. Anionic surfactants that may be used in the invention include surfactants such as alkali metal or ammonium salts of alkyl, aryl, or alkylaryl sulfonates, sulfates, phosphates, and mixtures thereof. Further suitable nonionic surfactants include, but are not limited to, alkyl and alkylaryl polydiol ethers, such as ethoxylation products of lauryl, oleyl and stearyl alcohols; and alkyl phenol glycol ethers, including but not limited to, ethoxylation products of octyl or nonylphenol. Further suitable surfactants may be found in McCutcheon's Volume I: Emulsifiers and Detergents 1996 North American Edition, MC Publishing Co., Glen Rock, N.J., 1996.

The surfactant may or may not be reactive in the polymerization. In one aspect, useful surfactants are the sulfate/sulfonate salts of nonyl phenol and alkyl alcohol ethoxylates. Surfactants may include, but are not limited to, one or more of polymerizable or nonpolymerizable alkyl ethoxylate sulfates, alkyl phenol ethoxylate sulfates, alkyl ethoxylates, and alkyl phenol ethoxylates.

When the stabilizer is a sulfopolyester, a low molecular weight sulfopolyester polymer may be utilized as a latex particle stabilizer in the polyol latex compositions. When included in the polyol latex compositions of the present invention, the sulfopolyester polymer can provide steric and ionic stabilization to latex particles to maintain the particles suspended in the continuous phase. Such stabilization is believed to result from the anionically charged groups in the polyester polymer chain of the sulfopolyester polymer. Accordingly, there may be no need to include surfactant in the compositions because the sulfopolyester polymers take the place thereof. However, a mixture of surfactant and sulfopolyester may be utilized in some aspects.

The sulfopolyester may be present in the polyol latex compositions at from 0.1 to 10 weight %. Still further, the amount of sulfopolyester may be from 1.0 to 10 weight % or from 1.0 to 5.0 weight %. Still further, the amount of sulfopolyester may be from 0.5, 1.0, 1.5, 2.0, 2.5, 3.0, 3.5, 4.0, 4.5 or 5.0 weight %, where any of the recited values may be utilized with any endpoint and vice versa. One of ordinary skill in the art would recognize that the type and amount of sulfopolyester used in the emulsion polymerization depends on the monomer combinations and the polymerization conditions.

The sulfopolyester polymers utilized as stabilizers in the polyol latex compositions herein contain a sulfo group. In a separate aspect, the sulfopolyesters may be linear polymers dispersible in the polyol latex compositions in the temperature range of 40 to 90° C. The sulfopolyester polymers of the present invention may contain repeat units comprising a dicarboxylic acid, a diol and a difunctional sulfo-monomer.

Dicarboxylic acids useful for sulfopolyester materials of the present invention include aromatic dicarboxylic acids preferably having from 8 to 14 carbon atoms, saturated aliphatic dicarboxylic acids preferably having from 4 to 12 carbon atoms, and cycloaliphatic dicarboxylic acids preferably having from 8 to 12 carbon atoms. Examples of dicarboxylic acids that may be utilized include, but are not limited to, one or more of terephthalic acid, phthalic acid, isophthalic acid, naphthalene-2,6-dicarboxylic acid, cyclohexanedicarboxylic acid, cyclohexanediacetic acid, diphenyl-4,4′-dicarboxylic acid, succinic acid, glutaric acid, adipic acid, azelaic acid and sebacic acid. In further aspects, the sulfo-polyester may be prepared from two or more of the above dicarboxylic acids. It should be understood that use of the corresponding acid anhydrides, esters, and acid chlorides of these acids is included in the term “dicarboxylic acids.”

The diol component of the low molecular weight sulfo-polyester polymers may include cycloaliphatic diols having from 6 to 20 carbon atoms, or aliphatic diols having from 3 to 20 carbon atoms. Examples of such diols include, but are not limited to, one or more of ethylene glycol, diethylene glycol, triethylene glycol, 1,4-cyclohexanedimethanol, propane-1,3-diol, butane-1,4-diol, pentane-1,5-diol, hexane-1,6-diol, 3-methyl-2,4-pentanediol, 2-methyl-1,4-pentanediol, 2-2-4-trimethyl-1,3-pentanediol; 1,3-hexanediol; 1,4-di-(hydroxyethoxy)-benzenediol; 2,2-bis-(4-hydroxycyclohexyl)-propanediol, 2,4-dihydroxy-1,1,3,3-trimethyl-cyclobutanediol and 2,2-bis-(4-hydroxypropoxyphenyl)-propanediol.

The difunctional sulfo-monomer component of the sulfopolyester polymer may be a dicarboxylic acid or an ester thereof containing a sulphonate group (—SO₃—), a diol containing a sulfonate group, or a hydroxy acid containing a sulfonate group. The cation of the sulfonate salt may be Na⁺, Li⁺, K⁺, NH₄⁺, and substituted ammonium. The term “substituted ammonium” refers to ammonium substituted with an alkyl or hydroxy alkyl radical having from 1 to 4 carbon atoms. In one aspect, the difunctional sulfo-monomers may contain at least one sulfonate group attached to an aromatic nucleus wherein the functional groups are hydroxy, carboxy or amino. Advantageous difunctional sulfo-monomer components are those wherein the sulfonate salt group is attached to an aromatic acid nucleus such as benzene, naphthalene, diphenyl, oxydiphenyl, sulfonyldiphenyl or a methylenediphenyl nucleus. In separate aspects of the invention herein, sulfophthalic acid, sulfoterephthalic acid, sulfoisophthalic acid, 4-sulfonaphthalene-2,7-dicarboxylic acid, and their esters, may be utilized. In a further aspect, the sulfo-monomer may be present in an amount of at least 10 mole percent, or from 8 to 25 mole percent, or from 12 to 20 mole percent, based on 100 mole percent dicarboxylic acid.

The inherent viscosity (IV) of the sulfopolyesters utilized in the invention herein may be in the range of from 0.1 to 0.5 dl/g, as measured in a 60/40 parts by weight solution of phenol/tetrachloroethane at 25° C., at a concentration of 0.25 grams of polymer in 100 mL of the solvent. The inherent viscosity of the sulfo-polyester may be from 0.28 to 0.35 dl/g.

In further aspects, the sulfopolyesters utilized in the present invention may be as follows:

| Sulfo- | | | | | | | |
|---|---|---|---|---|---|---|---|
| polyester | IPA | SIP | DEG | CHDM | EG | | |
| polymers | Mole % | Mole % | Mole % | Mole % | Mole % | I.V. | T_{g} |
| A | 89 | 11 | 100 | — | — | 0.42 | 29 |
| B | 89 | 11 | 72 | — | 28 | 0.43 | 35 |
| C | 89 | 11 | 78 | 22 | — | 0.36 | 38 |
| D | 76 | 24 | 76 | 24 | — | 0.29 | 48 |
| E | 82 | 18 | 54 | 46 | — | 0.33 | 55 |

In a further aspect of the invention herein, the sulfopolyester polymer stabilizers may be branched. The sulfopolyester polymers utilized in the invention may have a branched structure by virtue of the inclusion of multi-functional branching agent moieties during the condensation of the sulfopolyester polymer. Multi-functional branching agent moieties may have at least three functional groups, comprising hydroxyl, carboxyl, amino or copolymerizable derivatives of hydroxyl, carboxyl or amino functional groups. The three or more functional groups may be bonded to a common organic residue of the multifunctional branching agent. The chemical or geometrical structure of the organic residue may not be particularly critical, and may comprise any C₂-C₂₅ substituted or unsubstituted alkylene, alkyl, aryl or heterocyclic organic residue, which spaces the functional groups so that they are chemically accessible for polymerization. Multi-functional branching agents having four or more functional groups, and typically even more functional groups, may also be suitable.

In certain preferred embodiments, the multi-functional branching agent may be:

(a) an aliphatic polyol;

(b) an aromatic polyol;

(c) an aliphatic polyamine;

(d) an aromatic polyamine;

(e) an aliphatic polycarboxylic acid or the ester or anhydride thereof;

(f) an ethanolamine; or

(g) ethylenediaminetetraacetic acid or a salt or lower alkyl ester thereof.

Aliphatic polyol multi-functional branching agent moieties may include one or more of trimethylolpropane, trimethylolethane, glycerine, trimethylol propane, pentaerythritol, trimethylol propane, erythritol, threitol, dipentaerythritol and sorbitol. Trimethylolpropane may be the aliphatic multi-functional branching agent, primarily because of its low cost and ready availability.

Aromatic polyol multi-functional branching agent moieties may include one or more of phloroglucinol, tris(hydroxyphenyl)ethane, tris(hydroxyphenyl)methane, or lower alkyl or aryl esters thereof. Additional multi-functional branching agent moieties may include one or more of trimellitic acid, trimellitic anhydride, pyromellitic dianhydride, 1,3,5-triamino cyclohexane, 3,3′,4,4′-tetraminobiphenyl, triethanolamine and dimethylolpropionic acid.

The quantity of the multifunctional branching agent moieties may range from 0.1 to 40 mole %, or from 1 to 20 mole %, or from 2 to 6 mole % of the monomeric moieties condensed to form the water-dispersible sulfopolyester polymer. Alternative lower concentration limits for the multifunctional branching agent may include 0.5, 1.5, 2.5, 3, and 4 mole %.

In a further aspect, the sulfopolyesters may be unsaturated. The unsaturated copolymerizable acid or diol moieties, such as maleic acid, fumaric acid, itaconic acid, 4-carboxyl cinnamic acid, 2-butene-1,4-diol, 2-pentene-1,5-diol, and the like, may be incorporated into the polymer chain, generally at from 5 to 20 mole percent of the total acid or total diol components.

The low molecular weight sulfopolyester polymer stabilizer may or may not be reactive in the emulsion polymerization reaction in which the latex polymer compositions are prepared. In one aspect, useful sulfopolyester polymer stabilizers contain sulfonate salts as a part of the polyester chain. Polyesters may include, but are not limited to, polymerizable or nonpolymerizable groups with different percentages of anionic content in the polyester.

In one aspect of the invention herein, sulfopolyester polymer dispersions may be used as stabilizers for polyol latexes. The molecular weight of the sulfopolyester polymers used as stabilizers may be in the range of from 5,000 to 50,000; or from 8,000 to 25,000; or from 10,000 to 20,000.

The monomers that may be used to form the latex polymers may be broadly characterized as ethylenically unsaturated monomers. These include, but are not limited to, non-acid vinyl monomers, acid vinyl monomers, and mixtures thereof. The latex polymers of the invention may be copolymers of non-acid vinyl monomers and acid monomers, mixtures thereof, and their derivatives. The latex polymers of the invention may also be homopolymers of ethylenically unsaturated monomers.

Suitable ethylenically unsaturated monomers that may be used to prepare the latex polymer include, but are not limited to, one or more of acetoacetoxy ethyl methacrylate, acetoacetoxy ethyl acrylate, methyl acrylate, methyl methacrylate, ethyl acrylate, ethyl methacrylate, butyl acrylate, butyl methacrylate, isobutyl acrylate, isobutyl methacrylate, ethylhexyl acrylate, 2-ethylhexyl methacrylate, 2-ethyl hexyl acrylate, isoprene, octyl acrylate, octyl methacrylate, iso-octyl acrylate, iso-octyl methacrylate, trimethyolpropyl triacrylate, styrene, α-methyl styrene, glycidyl methacrylate, carbodiimide methacrylate, C₁-C₁₈ alkyl crotonates, di-n-butyl maleate, α or -β-vinyl naphthalene, di-octylmaleate, allyl methacrylate, di-allyl maleate, di-allylmalonate, methyoxybutenyl methacrylate, isobornyl methacrylate, hydroxybutenyl methacrylate, hydroxyethyl(meth)acrylate, hydroxypropyl(meth)acrylate, acrylonitrile, vinyl chloride, vinylidene chloride, vinyl acetate, vinyl ethylene carbonate, epoxy butene, 3,4-dihydroxybutene, hydroxyethyl(meth)acrylate, methacrylamide, acrylamide, butyl acrylamide, ethyl acrylamide, butadiene, vinyl ester monomers, vinyl(meth)acrylates, isopropenyl(meth)acrylate, cycloaliphaticepoxy(meth)acrylates, ethylformamide, 4-vinyl-1,3-dioxolan-2-one, 2,2-dimethyl-4 vinyl-1,3-dioxolane, and 3,4-di-acetoxy-1-butene, acrylic acid, methacrylic acid, itaconic acid, crotonic acid and monovinyl adipate. Suitable monomers are described in The Brandon Associates, 2nd edition, 1992 Merrimack, N.H., and in Polymers and Monomers, the 1966-1997 Catalog from Polyscience, Inc., Warrington, Pa., U.S.A.

Specific monomers useful for making the latex polymer/(co)polymer are ethylenically unsaturated monomers include, but are not limited to, one or more of acrylates, methacrylates, vinylesters, styrene, styrene derivatives, vinyl chloride, vinylidene chloride, acrylonitrile, isoprene and butadiene. In a further aspect, the latex polymer comprises (co)polymers made from monomers of 2-ethyl-hexyl acrylate, styrene, butylacrylate, butylmethacrylate, ethylacrylate, methylmethacrylate, butadiene or isoprene.

In one aspect, the molecular weight of the latex polymer is a weight average molecular weight (M_{w}) of from 1,000 to 1,000,000 as determined by gel permeation chromatography (GPC), or a number average molecular weight (Mn) of from 5000 to 250,000. Still further, the Mw of the latex polymer is greater than 10,000. In one aspect, the glass transition temperature (T_{g}) of the latex polymer is less than or equal to about 170° C.

The polyol latex compositions of the invention may be characterized as stabilized latexes in a continuous phase comprising a polyol component. A stable latex is defined for the purposes of this invention as one in which the particles are colloidally stable, i.e., the latex particles remain dispersed in the continuous phase for long periods of time, such as 24 hours, or 48 hours, or one week, or longer.

The latex polymer particles may generally have a spherical shape. As noted previously, the latex polymer utilized in the polyol latex compositions of the present invention may be a core shell polymer or a non core-shell polymer. When a core shell polymer is utilized, the polymers may be prepared in a core/shell fashion by staging the monomer addition. For example, the composition of the monomer feed of the polymerization may be changed over the course of the reaction in an abrupt fashion, resulting in a distinct core and shell portion to the polymer. In a further aspect, the latex polymer particles are not core shell polymers.

Monomers useful for making the core-shell and non-core shell latex polymer/(co)polymer are ethylenically unsaturated monomers including, but not limited to, one or more of acrylates, methacrylates, vinylesters, styrene, styrene derivatives, vinyl chloride, vinylidene chloride, acrylonitrile, isoprene and butadiene. In a further aspect, the core-shell latex polymer comprises (co)polymers made from monomers of one or more of 2-ethyl-hexyl acrylate, styrene, butylacrylate, butylmethacrylate, ethylacrylate, methylmethacrylate and butadiene isoprene.

The core/shell polymer particles may also be prepared in a multilobe form, a peanut shell, an acorn form, or a raspberry form. In such particles, the core portion can comprise from 20 to 80 percent of the total weight of the particle, and the shell portion can comprise from 80 to 20 percent of the total weight volume of the particle.

In one aspect, chain transfer agents may be used in the emulsion polymerization. Typical chain transfer agents are those known in the art. Chain transfer agents that may be used in the emulsion polymerization reaction to form the polyol latex compositions include, but are not limited to, one or more of butyl mercaptan, dodecyl mercaptan, mercaptopropionic acid, 2-ethylhexyl-3-mercaptopropionate, n-butyl-3-mercaptopropionate, octyl mercaptan, isodecyl mercaptan, octadecyl mercaptan, mercaptoacetate, allyl mercaptopropionate, allyl mercaptoacetate, crotyl mercaptoproprionate, crotyl mercaptoacetate, and the reactive chain transfer agents disclosed or described in U.S. Pat. No. 5,247,040, which is incorporated herein by reference in its entirety. The chain transfer agent may be selected from the mercaptans and various alkyl halides, including, but not limited to, carbon tetrachloride. Still further, the chain transfer agent may be 2-ethylhexyl-3-mercaptopropionate. Chain transfer agents can be added in amounts of from 0 to 2 parts per hundred monomer (phm), or from 0 to 0.5 phm.

The latex polymers of the invention can be uncrosslinked or crosslinked. When crosslinked, suitable crosslinking agents include multifunctional unsaturated compounds including, but not limited to, one or more of divinyl benzene, allyl methacrylate, allyl acrylate, and multifunctional acrylates. Suitable multifunctional acrylates include, but are not limited to, one or more of ethylene diol dimethacrylate, ethylene diol diacrylate, trimethylolpropane triacrylate, trimethylolpropane trimethacrylate, and pentaerythritoltetraacrylate. The amount of the crosslinking monomer in the emulsion polymerization can be controlled to vary the gel fraction of the latex from 20 to 100 percent. The gel fraction is the amount that will not dissolve in a good solvent.

The latex particles may be functionalized by including monomers having pendent functional groups. Functional groups that may be incorporated in the latex particle include, but are not limited to, one or more of epoxy groups, acetoacetoxy groups, carbonate groups, hydroxyl groups amine groups, isocyanate groups, and amide groups. The functional groups may be derived from a variety of monomers, including, but not limited to, one or more of glycidyl methacrylate, acetoacetoxy ethyl methacrylate, vinyl ethylene carbonate, hydroxyl ethyl methacrylate, t-butylaminoethyl methacrylate, dimethylamino methacrylate, m-isopropenyl-alpha, alpha-dimethylbenzyl isocyanate, acrylamide, and n-methylolacrylamide. The addition of functional groups may allow for further reaction of the polymer after latex synthesis.

Initiators can be used in the emulsion polymerization to form the polyol latex compositions, which include, but are not limited to, one or more of salts of persulfates, water, or diol soluble organic peroxides or azo type initiators. Initiators may include, but are not limited to, one or more of hydrogen peroxide, potassium or ammonium peroxydisulfate, dibenzoyl peroxide, lauryl peroxide, ditertiary butyl peroxide, 2,2′-azobisisobutyronitrile, t-butyl hydroperoxide and benzoyl peroxide. Redox initiation systems (Reduction Oxidation Initiation), such as iron catalyzed reaction of t-butyl hydroperoxide with isoascorbic acid, may also be useful. In one aspect, initiators capable of generating a strong acid as a by-product may not be used. This may avoid possible side reactions of the diol component of the solvent with the acid. Initiators can be added in amounts from 0.1 to 2 phm, or from 0.3 to 0.8 phm.

Reducing agents may also be used in the emulsion polymerization. Suitable reducing agents may be those that increase the rate of polymerization and include, for example, sodium bisulfite, sodium hydrosulfite, sodium formaldehyde sulfoxylate, ascorbic acid, isoascorbic acid or a mixture thereof. If a reducing agent is introduced into the emulsion polymerization, it may be added in an amount of 0.1 to 2 phm or from 0.3 to 0.8 phm. The reducing agent may be fed into the reactor over a period of time.

Buffering agents may also be used in the polyol-containing emulsion polymerization, to control the pH of the reaction. Suitable buffering agents may include, but are not limited to, one or more of: ammonium and sodium salts of carbonates and bicarbonates. The buffering agents included when using acid generating initiators, include, but are not limited to, the salts of persulfates.

Polymerization catalysts may also be used in the emulsion polymerization. Polymerization catalysts are those compounds that increase the rate of polymerization and which, in combination with the above-described reducing agents, may promote decomposition of the polymerization initiator under the reaction conditions. Suitable catalysts include, but are not limited to, transition metal compounds such as ferrous sulfate heptahydrate, ferrous chloride, cupric sulfate, cupric chloride, cobalt acetate and cobaltous sulfate.

In one aspect, the polyol latex composition may be prepared by first forming an emulsion or solution comprising monomers, an initiator, a surfactant, and a continuous phase. The mixture may then be heated, which generally causes the monomer to polymerize and form the latex polymers. Typically, the monomer may be fed into the reactor over a period of time, and a separate initiator feed may also be fed into the reactor over time.

The polyol latex composition may contain a stabilizer, or a stabilizer may not be present. Stabilizers suitable for use in the polyol latex composition include, but are not limited to, one or more of an anionic stabilizer, a nonionic suspension stabilizer, and an amphoteric suspension stabilizer. The suspension stabilizer must be soluble in the continuous phase, but should be substantially insoluble with the monomers. If present, the concentration of the suspension stabilizer is from 3 to 15 percent by weight of the monomers, or from 7 to 8 percent by weight of the monomers.

As the polyol concentration in the continuous phase approaches about 100%, the wetting properties of the polyol latex composition for hydrophobic surfaces generally improves, and the polyol latex composition becomes less volatile. The reduced volatility of the polyol latex composition may be especially advantageous when the polyol latex composition is used in a condensation reaction, as disclosed elsewhere herein.

The polymers produced by the invention may be useful for thermoplastic engineering resins, elastomers, films, sheets, and container plastics. The polyol latex compositions of the invention may be useful in a variety of coating compositions such as architectural coatings, maintenance coatings, industrial coatings, automotive coatings, textile coatings, inks, adhesives, and coatings for paper, wood, or plastics. Accordingly, the present invention further relates to such coating compositions containing a polyol latex composition of the invention. The polyol latex composition of the invention may be incorporated in those coating compositions in the same manner as known polymer latexes, and may be used with the conventional components and/or additives of such compositions. The coatings may be clear or pigmented.

In another aspect, the polyol latex compositions of the invention may also be formulated with a di- or multi-functional compound that is reactive toward hydroxyl functionality, such as diisocyanate, triisocyanate, polyisocyanate, isocyanate-functionalized polymer, blocked isocyanate, melamine-formaldehyde resin, and urea-formaldehyde resin. Such formulations may be used for two-pack coating, adhesive, and ink applications.

Examples of useful hydroxyl-reactive compounds include, but are not limited to, alkyl-etherized melamine resin, urea resin, and benzoguanamine resin, which are methylolated or modified with at least one of monohydric alcohols (with 1 to 5 carbon atoms) and compounds having an isocyanate or blocked isocyanate group. The compound having a blocked isocyanate group may be an isocyanate compound having its isocyanate group blocked with a blocking agent. Examples of useful isocyanate compounds include, but are not limited to, one or more of toluene diisocyanate, adduct of toluene diisocyanate and trimethylolpropane, diphenylmethane diisocyanate, methylene diisocyanate, hexamethylene diisocyanate, adduct of hexamethylene diisocyanate and trimethylolpropane, xylylene diisocyanate, lysine diisocyanate, etc. Examples of useful blocking agents include, but are not limited to, one or more of phenol, thiourea, methanol, propanol, n-butanol, t-butanol, ethyl acetoacetate, dimethyl malonate, ε-caprolactam, etc.

Upon formulation, a coating composition containing a polyol latex composition of the invention may then be applied to a variety of surfaces, substrates, or articles; e.g., paper, plastic, steel, aluminum, wood, gypsum board or galvanized sheeting (either primed or unprimed). The type of surface, substrate, or article to be coated generally determines the type of coating composition used. The coating composition may be applied using means known in the art. For example, a coating composition may be applied by spraying or by coating a substrate. In general, the coating may be dried by heating, but also may be allowed to air dry.

The coating composition contains the polyol latex composition of the invention, and may further contain water, a solvent, a pigment (organic or inorganic), and/or other additives or fillers known in the art. Such additives or fillers, include, but are not limited to, one or more of leveling, rheology, and flow control agents such as silicones, fluorocarbons, urethanes or cellulosics, extenders, reactive coalescing aids such as those described in U.S. Pat. No. 5,349,026 (the disclosure of which is incorporated herein by reference), flatting agents, pigment wetting and dispersing agents and surfactants, ultraviolet absorbers, ultraviolet light stabilizers, tinting pigments, extenders, defoaming and antifoaming agents, anti-settling, anti-sag and bodying agents, anti-skinning agents, anti-flooding and anti-floating agents, fungicides and mildewcides, corrosion inhibitors, thickening agents, plasticizers, reactive plasticizers, curing agents, and coalescing agents. Specific examples of such additives can be found in Raw Materials Index, published by the National Paint & Coatings Association, 1500 Rhode Island Avenue, NW, Washington, D.C. 20005, U.S.A.

The polyol latex compositions of the present invention can be utilized alone or in conjunction with other conventional polymers. Such polymers may include, but are not limited to, one or more of polyesters such as terephthalate based polymers, polyesteramides, cellulose esters, alkyds, polyurethanes, polycarbonates, epoxy resins, polyamides, acrylics, vinyl polymers, styrene-butadiene polymers, and vinylacetate-ethylene copolymers.

The polyol latex compositions of the invention may be useful as reactants in condensation polymerization reactions. As reactants in condensation polymerization reactions, the polyol latex compositions of this invention can be used to modify thermoplastic condensation polymers, by coreacting the polyol latexes with diacids, diisocyanates, or dialkyl, diaryl- or dihalo- carbonates. In addition, the invention can act as a convenient delivery method to deliver the latex polymer into the thermoplastic condensation polymer.

Accordingly, the invention further concerns the introduction of a polyol latex composition into a reaction that forms a condensation polymer, resulting in a product having polymer particles entrapped in a condensation polymer matrix. As used herein, the term “condensation polymerization” is used to refer to condensation polymerization reactions, and “condensation polymer” is the product thereof. The term “condensation polymerization” as used herein is also used to refer more generally to polymerization reactions of the step-growth-type. As used herein, the term “condensation polymer” is synonymous with “step-growth polymer.”

For the polyol latex composition to be introduced into the condensation polymerization reaction, the solvent or continuous phase may comprise polyol, with or without added co-solvent, as described above. In the polyol latex compositions, the polyols in the continuous phase co-react with one or more of the diacids, diisocyanates, or dialkyl, diaryl or dihalo carbonates that comprise the reaction medium that forms the condensation polymer. In this aspect, the polyol component is present in the amounts disclosed previously. The specific types of polyols that may be utilized are also as disclosed previously. As previously noted, in accordance with the present invention it is critical that the polyol latex compositions are essentially free of diol. Although the polyol latex composition must contain essentially no diol, the reaction medium to which the polyol latex is added may optionally contain some diol. In a particular embodiment, the polymer colloid system comprises the polyol latex composition described above. Alternatively, neither the polyol latex nor the condensation polymerization reaction medium contains any diol. Further, the reaction medium may contain both polyol and diol.

The process of the invention does not require the isolation of the latex polymer from the polyol latex composition prior to addition to the condensation polymerization reaction. Thus, in one aspect, the present invention may overcome the necessity of preparing a core shell polymer, i.e., a non-core shell polymer may be utilized; or the necessity of harvesting the polymer from the emulsion. Further, since blending takes place during the condensation polymer preparation, there may be no need for a polymer/polymer post blending step that is energy intensive, expensive, and often leads to the reduction of the molecular weight of the condensation polymer.

In some instances, a polyol latex composition comprising a core shell polymer may be utilized in the condensation polymerization. For example, when core shell polymers are utilized herein, transparent blends can be produced. Such blends may be obtained by coordinating or by closely matching the refractive indices of the core shell polymer with that of the condensation polymer matrix. Such techniques are described generally in U.S. Pat. No. 5,409,967, the disclosure of which is incorporated herein by reference in its entirety.

In one aspect, the reaction medium in which the polyol latex compositions of the invention are introduced forms polyester polymers. The term “polyester,” as used herein, refers to any unit-type of polyester falling within the scope of the polyester portion of the blend, including, but not limited to, homopolyesters and copolyesters (two or more types of acid and/or polyol residues of monomeric units). The polyesters of the present invention comprise an acid residue and a polyol residue and, optionally, a diol residue, where such diol residue is derived from the condensation polymerization latex reaction medium, not the polyol latex continuous phase. The acid residues of the polyesters of the present invention total 100 mol %, and the hydroxyl residues of the polyesters of the present invention total 100 mol %. It should be understood that use of the corresponding derivatives, specifically acid anhydrides, esters and acid chlorides of these acids, is included throughout the application in the term “acid residue.” In addition to the acid residue and the polyol residue, the polyester may comprise other modifying residues. These modifying residues include, but are not limited to, a diamine, which would result in a polyester/amide.

Examples of dicarboxylic acids or derivatives that may be used to prepare the polyester are terephthalic acid or ester and 2,6-napthalenedicarboxylic acid or ester, succinic, isophthalic, glutaric, and adipic acid or ester. Other naphthalenedicarboxylic acids or their esters may also be used. These include the 1,2-, 1,3-, 1,4-, 1,5-, 1,6-, 1,7-, 1,8-, 2,3-, 2,4-, 2,5-, 2,6-, 2,7-, and 2,8- naphthalenedicarboxylic acids or a mixture thereof. Even more preferred is the 2,6-napthalenedicarboxylic acid as the modifying acid.

As noted, the source of hydroxyls for the polyester may be derived from a diol, where the source of the diol is not the polyol latex composition. The diol component of the polyester comprises residues of diols that may be selected from cycloaliphatic diols that may have from 6 to 20 carbon atoms, or aliphatic diols preferably having from 2 to 20 carbon atoms. Examples of such diols include, but are not limited to, one or more of ethylene diol, diethylene diol, triethylene diol, neopentyl diol, 1,4 butanediol, 1,6 hexanediol 1,4-cyclohexanedimethanol, 1,3-propanediol, 1,10-decanediol, 2,2,4,4,-tetramethyl-1,3-cyclobutanediol, 3-methyl-2,4-pentanediol, 2-methyl-1,4-pentanediol, 2,2,4-trimethyl-1,3-pentanediol, 2-ethyl-1-1,3-hexanediol, 2,2-diethyl-1,3-propanediol, 1,3-hexanediol, 1,4-bis-(hydroxyethoxy)benzene, 2,2-bis-(4-hydroxycyclohexyl)-propane, 2,4-dihydroxy-1,1,3,3-tetramethylcyclobutane, 2,2-bis-(3-hydroxyethoxyphenyl)propane and 2,2-bis-(4-hydroxypropoxyphenyl)propane. The diol component may be selected from one or more of ethylene diol, 1,4-butanediol, neopentyl diol, cyclohexanedimethanol and diethylene diol. The diols may be modified with up to about 50 mol %, and/or from up to about 20 mol % of any of the other diols disclosed herein.

The polymers of the invention may be buffered. Buffers may include one or more of sodium acetate, potassium acetate, lithium acetate, sodium phosphate monobasic, potassium phosphate dibasic, and sodium carbonate. Buffering agents are useful to limit the amount of acidic species which, in turn, causes dehydration of the diols to give ether diol. Accordingly, it can be desirable to limit such acid species through the use of buffering agents.

An agent comprising one or more ion-containing monomers may be added to increase the melt viscosity of the polyesters. The ion-containing monomers useful in the invention include, but are not limited to, alkaline earth metal salts of sulfisophthalic acid and derivatives thereof. The weight percentage for ion-containing monomers may be from 0.3 to 5.0 mole %, or from 0.3 to 3.0 mole %. The ion-containing monomers also increase the melt viscosity of the polyesters and do not reduce the elongation of the films to substantially low levels.

The homo- or copolyesters of the invention may be prepared in reaction carried out using polyols; diols, where polyol and/or diol are present in the reaction medium; and diacids (or diesters or anhydrides), at temperatures from 150° C. to 300° C., in the presence of polycondensation catalysts, including, but not limited to, one or more of titanium tetrachloride, titanium tetraisopropoxide, manganese diacetate, antimony oxide, antimony triacetate, dibutyl tin diacetate and zinc chloride. The catalysts are typically employed in amounts between 10 to 1000 ppm, based on the total weight of the reactants. The final stage of the reaction is generally conducted under high vacuum (<10 mm of Hg) in order to produce a high molecular weight polyester.

In another aspect of the invention, a polycarbonate may be modified by introduction of the polyol latex composition into the reaction medium. The polycarbonates that may be modified, include, but are not limited to, homopolymers, copolymers, or mixtures thereof, that are prepared by reacting a dihydric phenol with a carbonate precursor. The dihydric phenols which may be used to produce the carbonate, include, but are not limited to, one or more of bisphenol-A, (2,2-bis(4-hydroxyphenyl)propane), bis(4-hydroxyphenyl)methane, 2,2-bis(4-hydroxy-3-methylphenyl)propane, 4,4-bis(4-hydroxyphenyl heptane), 2,2-(3,5,3′,5′-tetrachloro-4,4′-dihydroxydiphenyl)propane, 2,2-(3,5,3′,5′-tetrabromo-4,4′-dihydroxydiphenyl)propane and (3,3′-dichloro-4,4′-dihydroxydiphenyl) methane. Branching agents useful in preparing the polycarbonate of the invention include, but are not limited to, one or more of glycerol, pentaerythritol, trimellitic anhydride, pyromellitic dianhydride and tartaric acid. If branching agents are used in the condensation polymerization reaction, a preferred range for the branching agent is from 0.1 to 2.0 weight %, or from about 0.2 to 1.0 weight %, based on the total weight of the polycarbonate.

In another embodiment of the invention, the condensation polymer to be modified by introduction of the polyol latex composition may comprise a polyurethane. The polyurethane that may be modified comprises residues of a diol or diols, and residues of a di-isocyanate or di-isocyanates. The diol residues of the polyurethane may be derived from diols including, but not limited to, one or more of 1,3-cyclobutanediol, 1,3-cyclopentanediol, 1,2-cyclohexanediol, 1,3-cyclohexanediol, 1,4-cyclohexanediol, 2-cyclohexane-1,4-diol, 2-methyl-1,4-cyclohexanediol, 2-ethyl- 1,4 cyclohexanediol, 1,3-cycloheptanediol, 1,4 cycloheptanediol, 2-methyl-1,4 cycloheptanediol, 4-methyl-1,3-cycloheptanediol, 1,3-cyclooctanediol, 1,4 cyclooctanediol, 1,5 cyclooctanediol, 5-methyl-1,4-cyclooctanediol, 5-ethyl-1,4-cyclooctanediol, 5-propyl- 1,4 cyclooctanediol, 5-butyl,1,4-cyclooctanediol, 5-hexyl-1,4-cyclooctanediol, 5-heptyl-1,4-cyclooctanediol, 5-octyl-1,4 cyclooctanediol, 4,4′methylenebis(cyclohexanol), 4,4′-methylenebis(2-methylcyclohexanol), 3,3′-methylenebis(cyclohexanol), 4,4′ethylenebis(cyclohexanol), 4,4′propylenebis(cyclohexanol), 4,4′butylenebis(cyclohexanol), 4,4′isopropylidenebis(cyclohexanol), 4,4′isobutylenebis(cyclohexanol), 4,4′dihydroxydicyclohexyl, 4,4′carbonylbis(cyclohexanol), 3,3′-carbonylbis(cyclohexanol), 4,4′sulfonylbis(cyclohexanol) and 4,4′-oxybis(cyclohexanol).

The polyurethanes of the invention can be prepared using any known methods for bringing together, in the presence or absence of solvents, polyisocyanates, extenders, and optionally, high molecular weight polyols. This includes manual or mechanical mixing means including casting, reaction extrusion, reaction injection molding, and related processes. Typical preparative methods useful in the instant invention are disclosed in U.S. Pat. Nos. 4,376,834 and 4,567,236, incorporated herein by reference, which disclosures relate to polyurethane plastic forming ingredients and preparative procedures.

The mixing of the reactants may be carried out at ambient temperature, i.e., at a temperature from 20° C. to 25° C. The resulting mixture is preferably heated to a temperature from 40° C. to 130° C., more preferably from 50° C. to 100° C. One or more of these reactants may be heated to a temperature within these ranges before admixing.

A catalyst may optionally be included in the reaction mixture used to prepare the polyurethanes. Any of the catalysts conventionally employed in the art to catalyze the reaction of an isocyanate with a reactive hydrogen-containing compound may be used for this purpose. Suitable catalysts are disclosed in U.S. Pat. No. 4,202,957 at column 5, lines 45 to 67, incorporated herein by reference. The amount of catalysts used may be within the range of about 0.02 to 2.0 percent by weight, based on the total weight of the reactants. In a particular aspect of the one-shot procedure, the reaction may be carried out on a continuous basis using apparatus and procedures such as that disclosed in U.S. Pat. No. 3,642,964, also disclosed herein by reference.

The polyurethanes of this invention may include both thermoplastic injection-moldable and thermoset (foam-type) resins. The thermoplastic resins may be obtained by employing substantially difunctional polyisocyanates and difunctional extenders, and a polyol having a functionality preferably not exceeding 4, although polyols having higher functionalities may be employed where the weight proportion used in a low range. As will be recognized by those skilled in the art, this limit will vary according to the nature of the polyol, the molecular weight of the polyol, and the amount of polyol used. In general, the higher the molecular weight of the polyol, the higher the functionality which can be employed without losing the thermoplastic properties in the polyurethane product.

The di-isocyanante residue may be derived from di-isocyanates including, but not limited to, one or more of methylenebis(phenyl isocyanate) including the 4,4′-isomer, the 2,4′isomer, or a mixture thereof, m- and p-phenylene diisocyanates, chlorophenylene diisocyanates, α,β-xylene diisocyanate, 2,4-and 2,6-toluene diisocyanates or a mixture of these latter two isomers, tolidine diisocyanate, hexamethylene diisocyanate, 1,5-naphthalene diisocyante, isophorone diisocyanate and the like, cycloaliphatic diisocyanates such as methylenebis(cyclohexyl isocyanate) including the 4,4′isomer or the 2,4′isomer, and all the geometric isomers thereof including trans/trans, cis/trans, cis/cis or mixtures thereof, cyclohexylene diisocyanantes (1,2, 1,3 or 1,4-), 1-methyl-2,5-cyclohexylene diisocyanate, 1-methyl-2,4 cyclohexylene diisocyanate, 1-methyl-2,6-cyclohexyl diisocyanate, 4,4′-isopropylidenebis(cyclohexyl isocyanate), 4,4′-diisocyanatodicyclohexyl and all geometric isomers, and mixtures thereof. Also included are the modified forms of methylenebis(phenylisocyanate). By the latter are meant those forms of methylenebis(phenyl isocyanate) that have been treated to render them stable liquids at ambient temperature. Such products include those which have been reacted with a minor amount (up to about 0.2 equivalents per equivalent of polyisocyanate) of an aliphatic diol or a mixture of aliphatic diols such as the modified methylenebis(phenyl isocyanates) described in U.S. Pat. Nos. 3,394,164; 3,644,457; 3,883,571; 4,031,026; 4,115,429; 4,118,411; and 4,299,347, each of which is incorporated herein by reference.

The modified methylenebis(phenyl isocyanates) also include those which have been treated so as to convert a minor proportion of the diisocyanate to the corresponding carbodiimide, which then interacts with further diisocyanate to form the aeration-imine groups, the resulting product being a stable liquid at ambient temperatures, as described, for example, in U.S. Pat. No. 3,384,653, incorporated herein by reference. Mixtures of any of the above-named polyisocyanates can be employed if desired.

Further, in the case of the preparation of those polyurethanes of the invention which are thermoset, it is possible to introduce into the polyisocyanate component employed in the reaction, minor amounts (up to about 30 percent by weight) of polymethylene polyphenyl polyisocyanates. The latter are mixtures containing from about 20 to about 90 percent by weight of methylenebis(phenyl isocyanate), the remainder of the mixture being polymethylene polyphenyl polyisocyanates of functionality higher than about 2.0. Such polyiscoyanates and methods for their preparation are well known in the art. See, for example, U.S. Pat. Nos. 2,683,730, 2,950,263, 3,012,008 and 3,097,191, each of which is incorporated herein by reference.

Branching agents useful in preparing the polyurethane of the invention include, but are not limited to, one or more of glycerol, pentaerythritol, trimellitic anhydride, pyromellitic dianhydride, tartaric acid, and mixtures thereof. If branching agents are used in the condensation reaction, a preferred range for the branching agent is from 0.1 to 2.0 weight %, more preferably from about 0.2 to 1.0 weight %, based on the total weight of the polymer.

When the condensation polymer is a polyurethane and the polymer colloid system is a rubber component consisting of one or more of isoprene, chloroprene, butadiene, SBR (styrenelbutadiene rubber), isobutene, isoprene and EPDM, the resulting condensation polymer/first polymer blend may have an equilibrium water absorption of less than 10 weight %.

Other ingredients may optionally be added to the compositions of the present invention to enhance the performance properties of the condensation polymer/latex polymer matrix. For example, one or more of surface lubricants, denesting agents, stabilizers, antioxidants, ultraviolet light absorbing agents, mold release agents, metal deactivators, colorants such as black iron oxide and carbon black, nucleating agents, phosphate stabilizers, zeolites, fillers, and reinforcing agents, can be included herein. All of these additives and the use thereof are well known in the art. Any of these compounds can be used so long as they do not hinder the present invention from accomplishing its objects.

In one aspect relating to the addition of reinforcing agents to the compositions of the present invention, glass fibers may be added to the condensation polymer compositions to provide particular advantages to the resulting compositions. Glass fibers that may be utilized in the present invention conventionally have an average standard diameter of greater than 5 microns, with a range of 10 to 20 microns. The length of the glass filaments, whether or not they are bundled into fibers, and whether the fibers are further bundled into yarns, ropes or rovings, and the like, are not critical to this invention. However, for the purpose of preparing the present compositions, filamentous glass may be utilized in the form of chopped strands of from 1.5 mm to 10 mm long, and of from less than 6 mm long. In the pellets and molded articles of the compositions, even shorter lengths may be encountered because, during compounding, considerable fragmentation occurs. This may be desirable, however, because the best properties are exhibited for injection-molded articles where the filament lengths are between 0.03 mm and 1 mm. Glass fibers having an average standard diameter in the range of greater than 5 may be used, or from 5 to 14, and the average filament length dispersed in the molded articles being between 0.15 and 0.4 mm. Consequently, glass filaments are generally dispersed uniformly, and the molded articles exhibit uniform and balanced mechanical properties, especially surface smoothness.

The amount of the glass fibers can vary broadly from 10 to 50 weight %, or from 10 to 40 weight %, based on the total polymer composition. These glass fibers are typically conventionally sized with coupling agents, such as aminosilanes and epoxysilanes and titanates, and adhesion promoters such as one or more of epoxies, urethanes, cellulosics, starch, and cyanurates.

In one aspect, when the glass fiber is present in the polymer molding composition, the polymer may be from 70 to 85 weight % of the total composition, based on the total weight percentages of the first and second polymers equaling 100 weight %. The polymer in the polymer molding composition may comprise polyester.

Examples of other reinforcing agents that are useful in addition to glass fibers, include, but are not limited to, one of more of carbon fibers, mica, clay, talc, wollastonite, and calcium carbonate. The polymer compositions of the invention may be reinforced with a mixture of glass and other reinforcing agents as described above, such as mica or talc, and/or with other additives.

In accordance with the invention herein, the polymer colloid system and glass fibers, as well as other reinforcing agents, may be introduced into the condensation polymerization reaction at various stages of the process. In one aspect of the invention herein, the glass fibers may be added directly to the condensation polymerization reaction. Since the glass fibers can be sufficiently blended during this stage, there may be no need for a post-blending step, such as extrusion, to incorporate the glass fibers into the compositions. This may be particularly advantageous to the present invention, because a post-blending step is energy intensive, expensive, and may cause a reduction in the molecular weight of the condensation polymer.

End-use applications for the compositions of the condensation polymers produced according to the instant invention include one or more of impact-modified polymers, elastomers, high barrier films and coatings, improved barrier polymers, and polymers having improved mechanical properties, such as improved tensile strength, improved elongation at break, better weathering properties, improved heat deflection temperatures, and improved flexural strength. Other end-use applications include engineering resins, coatings, containers for barrier applications, and molding plastics. In addition, powder coatings may be produced from the modified condensation polymers produced according to the invention. The polymers produced by this invention are useful for one or more of thermoplastic engineering resins, elastomers, films, sheets, and container plastics.

In a further aspect, an impact-modified polyester may be prepared comprising a core shell or a non-core shell first polymer derived from a polyol latex composition. In another embodiment, a hydroxyl functionalized polyester coating is prepared comprising a core shell or a non core shell first polymer derived from a polyol latex composition.

In another aspect, a condensation polymer that is transparent or semi-transparent may be formed. As noted previously, such polymers may be formed by closely matching the refractive index of a polymer utilized as the first polymer with the refractive index of the condensation polymer matrix.

In another aspect of the invention, a modified condensation polymer, including, but not limited to, an impact modified plastic, may be produced from a polyol latex composition comprising latex polymers that are core shell or non core shell polymers, and a condensation polymer. The latex polymer in this embodiment may have a T_{g} of less than 40° C., while the condensation polymer may have a Tg of greater than 40° C. The impact-modified plastic may be prepared from the polyol latex compositions of the present invention.

In another aspect of the invention, a modified condensation polymer, including but not limited to a thermoplastic elastomer, may be produced from a polyol latex composition comprising latex polymers which are non-core shell polymers. The first latex polymer in this aspect may have a T_{g} greater than 40° C., and the condensation polymer may have a T_{g} less than 40° C. The condensation polymer may have a T_{g} of less than 0° C. and essentially no crystallinity, or the condensation polymer may have a T_{g} of less than −20° C. and essentially no crystallinity. In a further aspect, both the latex polymer and the condensation polymer may have a T_{g} of less than 40° C.

In another aspect of the invention, a modified condensation polymer, including but not limited to a thermoplastic elastomer, may be produced from a polyol latex composition where the latex is a core shell polymer. The latex polymer in this aspect may have a T_{g} greater than about 40° C., and the condensation polymer may have a T_{g} less than about 40° C. The condensation polymer may have a T_{g} of less than 0° C. and essentially no crystallinity, or the condensation polymer may have a T_{g} of less than −20° C. and essentially no crystallinity. In a further aspect, both the latex polymer and the condensation polymer may have a T_{g} of less than 40° C.

Elastomers are finding increasing utility, in particular thermoplastic elastomers (TPE's) that are elastomeric at use temperature, but can be processed as a plastic (e.g., injection molding, extruded) at appropriate temperatures. In a further aspect of this invention, an elastomer may be prepared according to the process of the invention. For example, a condensation polymer that is amorphous and has a low T_{g} may be a viscous fluid that is not useful as a plastic or elastomer. This low T_{g} viscous polymer may be used to make an elastomer by adding a latex polymer that can act as a physical cross-linker and is a tie-point for the viscous polymer chains. A phase separated polymer blend will generally result that has elastomeric properties.

### EXAMPLES

The following examples are intended to provide to those of ordinary skill in the art a complete disclosure and description of how the compositions of matter and methods claimed herein are made and evaluated, and are not intended to limit the scope of what the inventors regard as their invention. Efforts have been made to ensure accuracy with respect to numbers (e.g., amounts, temperature, etc.), but some errors and deviations may be present. Unless indicated otherwise, parts are by weight, temperature is in ° C. or is at room temperature, and pressure is at or near atmospheric.

### Example 1

### Preparation of an NPG-Based Latex

40.0 g of a low molecular weight sulfopolyester (AQ-55, Eastman Chemical Co., Kingsport, Tenn.) was dispersed in a solution of water (160.0 g) and NPG (310.0 g) at 50-65° C. The resulting solution was then added to a 1L jacketed reaction kettle equipped with a condenser, nitrogen gas, and a stirrer. Separately, a monomer mixture containing 2-ethyhexyl acrylate (185.0 g), methyl methacrylate (40.0 g), and methacrylic acid (15.0 g), was prepared in a 500 ml flask. In another container, 1.0 g of t-butyl hydroperoxide (70% in water), used as an initiator, was diluted with water (38.3 g). A solution of sodium formaldehyde sulfoxylate (SFS) (0.70 g) and water (10.0 g) was also prepared.

To the above reaction kettle were added 0.50 g of iron (II) sulfate heptahydrate (1.0 wt % in water), 0.40 g of ethylenediaminetetraacetic acid diammonium salt hydrate (EDTA), and a half portion of the above SFS solution. The reaction mixture was heated to 80° C. To the heated reactor, the monomer mixture and the initiator solution prepared above were pumped separately, over a period of 2-3 hours. In the middle of the reaction, the other half portion of the SFS solution was added. After all the monomers and initiator were added, the reaction was held for an additional hour to complete the polymerization. The mixture was then allowed to cool to room temperature. The resulting latex was filtered through a multi-layered cheese-cloth. The solids content of the latex was determined to be 34.72% by drying in an oven at 100° C. The molecular weight was determined by GPC to be 15,263 (Mn, number average molecular weight), and 204,225 (Mw, weight average molecular weight). The particle size analysis showed a trimodal distribution centered at about 0.15, 4.00, and 40.00 μm.

### Example 2

### Preparation of a Glycerol-Based Latex

40.0 g of a low molecular weight sulfopolyester (AQ-55) was dispersed in 40.0 g glycerol at 80° C. The resulting solution was then added to a IL jacketed reaction kettle equipped with a condenser, nitrogen gas, and a stirrer. Separately, a monomer mixture containing 2-ethyhexyl acrylate (185.0 g), methyl methacrylate (40.0 g), and methacrylic acid (15.0 g), was prepared in a 500 ml flask. In another container, 1.0 g of t-butyl hydroperoxide (70% in water), used as an initiator, was mixed with glycerol (38.3 g). A solution of sodium formaldehyde sulfoxylate (SFS) (0.70 g), water (2.10 g), and glycerol (2.04 g), was also prepared.

To the above reaction kettle were added 0.52 g of iron (II) sulfate heptahydrate (1.0 wt % in water), 0.41 g of ethylenediaminetetraacetic acid diammonium salt hydrate (EDTA), and a portion (1.5 ml) of the above SFS solution. The reaction mixture was heated to 80° C. To the heated reactor, the monomer mixture and the initiator solution prepared above were pumped separately over a period of 2-3 hours. During the reaction, the rest of the SFS solution was added in three portions. After all the monomers and initiator were added, the reaction was held for an additional hour to complete the polymerization. The mixture was then allowed to cool to room temperature. The resulting latex was filtered through a multi-layered cheese-cloth. The molecular weight was determined by GPC to be 57,458 (Mn, number average molecular weight), and 464,803 (Mw, weight average molecular weight). The particle size analysis of the latex showed a bimodal particle size distribution centered at 0.17 and 56 μm.

### Example 3

### Preparation of a Glycerol-Based Latex

40.0 g of a low molecular weight sulfopolyester (AQ-55) was dispersed in glycerol (376.0 g) and water (94.0 g) at 80° C. The resulting solution was then added to a IL jacketed reaction kettle equipped with a condenser, nitrogen gas, and a stirrer. Separately, a monomer mixture containing 2-ethyhexyl acrylate (96.0 g), methyl methacrylate (108.0 g), and methacrylic acid (36.0 g), was prepared in a 500 ml flask. In another container, 1.0 g of t-butyl hydroperoxide (70% in water), used as an initiator, was mixed with glycerol (38.3 g). A solution of sodium formaldehyde sulfoxylate (SFS) (0.70 g), water (2.02 g), and glycerol (2.04 g), was also prepared.

To the above reaction kettle were added 0.52 g of iron (II) sulfate heptahydrate (1.0 wt % in water), 0.41 g of ethylenediaminetetraacetic acid diammonium salt hydrate (EDTA), and a portion (1.5 ml) of the above SFS solution. The reaction mixture was heated to 80° C. To the heated reactor the monomer mixture and the initiator solution prepared above were pumped separately over a period of 2-3 hours. During the reaction, the rest of the SFS solution was added in three portions. After all the monomers and initiator were added, the reaction was held for an additional hour to complete the polymerization. The mixture was then allowed to cool to room temperature. The resulting latex was filtered through a multi-layered cheese-cloth. The molecular weight was determined by GPC to be 62,289 (Mn, number average molecular weight), and 605,494 (Mw, weight average molecular weight). The particle size analysis of the latex showed a bimodal particle size distribution centered at 0.13 and 170 μm.

### Example 4

### Preparation of a Glycerol-Based Latex

40.0 g of a low molecular weight sulfo-polyester (AQ-55) was dispersed in glycerol (282.0 g) and water (182.0) at 80° C. The resulting solution was then added to a IL jacketed reaction kettle equipped with a condenser, nitrogen gas, and a stirrer. Separately, a monomer mixture containing 2-ethyhexyl acrylate (48.2 g), styrene (48.2 g), methyl methacrylate (108.6 g), and methacrylic acid (36.1 g), was prepared in a 500 ml flask. In another container, 1.0 g of t-butyl hydroperoxide (70% in water), used as an initiator, was mixed with glycerol (38.3 g). A solution of sodium formaldehyde sulfoxylate (SFS) (0.70 g), water (2.49 g), and glycerol (2.52 g), was also prepared.

To the above reaction kettle were added 0.52 g of iron (II) sulfate heptahydrate (1.0 wt % in water), 0.41 g of ethylenediaminetetraacetic acid diammonium salt hydrate (EDTA), and a portion (1.5 ml) of the above SFS solution. The reaction mixture was heated to 80° C. To the heated reactor, the monomer mixture and the initiator solution prepared above were pumped separately over a period of 2-3 hours. During the reaction, the rest of the SFS solution was added in three portions. After all the monomers and initiator were added, the reaction was held for an additional hour to complete the polymerization. The mixture was then allowed to cool to room temperature. The resulting latex was filtered through a multi-layered cheese-cloth. The molecular weight was determined by GPC to be 151,550 (Mn, number average molecular weight), and 696,757 (Mw, weight average molecular weight). The particle size analysis of the latex showed a major peak centered at 0.11 and a very small peak centered at 64 μm.

### Example 5

### Preparation of a Glycerol-Based Latex

40.0 g of a low molecular weight sulfopolyester (AQ-55) was dispersed in glycerol (282.0 g) and water (182.0) at 80° C. The resulting solution was then added to a IL jacketed reaction kettle equipped with a condenser, nitrogen gas, and a stirrer. Separately, a monomer mixture containing 2-ethylhexyl acrylate (48.0 g), styrene (48.0), methyl methacrylate (108.1 g), and methacrylic acid (36.0 g), was prepared in a 500 ml flask. In another container, 1.2 g of t-butyl hydroperoxide (70% in water), used as an initiator, was mixed with water (38.3 g). A solution of sodium formaldehyde sulfoxylate (SFS) (0.70 g), water (3.02 g), and glycerol (3.03 g), was also prepared.

To the above reaction kettle were added 0.52 g of iron (II) sulfate heptahydrate (1.0 wt % in water) and a portion (1.5 ml) of the above SFS solution. The reaction mixture was heated to 80° C. To the heated reactor, the monomer mixture and the initiator solution prepared above were pumped separately over a period of 2-3 hours. During the reaction, the rest of the SFS solution was added in three portions. After all the monomers and initiator were added, the reaction was held for an additional hour to complete the polymerization. The mixture was then allowed to cool to room temperature. The resulting latex was filtered through a multi-layered cheese-cloth. The molecular weight was determined by GPC to be 61,872 (Mn, number average molecular weight), and 437,499 (Mw, weight average molecular weight). The particle size analysis of the latex showed a bimodal particle size distribution centered at about 0.14 and 65 μm.

### Example 6

### Preparation of a Glycerol-Based Latex

Hitenol HS-20 (5.3 g), polymerizable polyoxyethylene alkyl phenyl ether ammonium sulfate (available from DKS International), was dispersed in glycerol (282.0 g) and water (188.0 g) at 80° C. The resulting solution was then added to a lL jacketed reaction kettle equipped with a condenser, nitrogen gas, and a stirrer. Separately, a monomer mixture containing 2-ethyhexyl acrylate (48.0 g), styrene (48.0), methyl methacrylate (108.0 g), and methacrylic acid (36.0 g), was prepared in a 500 ml flask. In another container, 1.0 g of t-butyl hydroperoxide (70% in water), used as an initiator, was mixed with water (38.3 g). A solution of sodium formaldehyde sulfoxylate (SFS) (0.7 g), water (3.0 g), and glycerol (3.0 g), was also prepared.

To the above reaction kettle were added 0.52 g of iron (II) sulfate heptahydrate (1.0 wt % in water), 0.41 g of ethylenediaminetetraacetic acid diammonium salt hydrate (EDTA), and a portion (1.5 ml) of the above SFS solution. The reaction mixture was heated to 80° C. To the heated reactor, the monomer mixture and the initiator solution prepared above were pumped separately over a period of 2-3 hours. During the reaction, the rest of the SFS solution was added in three portions. After all the monomers and initiator were added, the reaction was held for an additional hour to complete the polymerization. The mixture was then allowed to cool to room temperature. The resulting latex was filtered through a multi-layered cheese-cloth.

### Example 7

### Preparation of TMP-Based Latex

The low molecular weight sulfo-polyester AQ-55 (40.0 g) was dispersed in trimethylolpropane (TMP, 282.0 g) and water (188.0) at 80° C. The resulting solution was then added to a 1L jacketed reaction kettle equipped with a condenser, nitrogen gas, and stirrer. Separately, a monomer mixture containing n-butyl acrylate (47.0 g), styrene (47.0), methyl methacrylate (94.0 g), and acrylic acid (12.0 g) was prepared in a 500 ml flask. In another container, 1.01 g of t-butyl hydroperoxide (70% in water), used as an initiator was mixed with water (38.32 g). A solution of sodium formaldehyde sulfoxylate (SFS) (0.71 g) and water (6.02 g) was also prepared.

To the above reaction kettle were added 0.51 g of iron (II) sulfate heptahydrate (1.0 wt % in water) and a portion (1.5 ml) of the above SFS solution. The reaction mixture was heated to 80° C. To the heated reactor, the monomer mixture and the initiator solution prepared above were pumped separately over a period of 2-3 hours. During the reaction, the rest of the SFS solution was added in three portions. After all the monomers and initiator were added, the reaction was held for an additional hour to complete the polymerization. The mixture was then allowed to cool to room temperature. The resulting latex was filtered through a multi-layered cheese-cloth. The molecular weight was determined by GPC to be 60,700 (Mn, number average molecular weight), and 442,000(Mw, weight average molecular weight). The particle size analysis of the latex showed a bimodal particle size distribution centered at about 0.17 and 74 μm.

The invention has been described in detail, with reference to specific embodiments, but those of ordinary skill in the art will appreciate that variations and modifications exist, and are intended to fall within the scope and spirit of the invention.

We claim:

1. A polyol latex composition, comprising:
a. latex polymer particles comprising a residue of an ethylenically unsaturated monomer;
b. a stabilizer comprising at least one of a surfactant and a sulfopolyester; and
c. a liquid continuous phase comprising a polyol component at from greater than 10% to 100 weight % of the continuous phase, wherein the continuous phase is essentially free of a diol component.

2. The polyol latex composition of claim 1, wherein the polyol component comprises from 40 to 100 weight % of the continuous phase.

3. The polyol latex composition of claim 1, wherein the polyol component comprises from 75 to 100 weight % of the continuous phase.

4. The polyol latex composition of claim 1, wherein the continuous phase consists essentially of the polyol component.

5. The polyol latex composition of claim 1, wherein the continuous phase comprises a water component.

6. The polyol latex composition of claim 1, wherein the stabilizer comprises a surfactant selected from the group consisting of an anionic surfactant, a cationic surfactant, a nonionic surfactant, and mixtures thereof.

7. The polyol latex composition of claim 6, wherein the surfactant comprises at least one member selected from the group consisting of a polymerizable or nonpolymerizable alkyl ethoxylate sulfate, alkyl phenol ethoxylate sulfate, alkyl ethoxylate, or alkyl phenol ethoxylate.

8. The polyol latex composition of claim 6, wherein the stabilizer comprises a surfactant in an amount of from 0.1% to 10 weight % of the latex composition.

9. The polyol latex composition of claim 1, wherein the stabilizer comprises a sulfopolyester comprising residues of a polycarboxylic acid, a diol and a difunctional sulfo-monomer.

10. The polyol latex composition of claim 9, wherein the difunctional sulfo-monomer comprises from 8 mole % to 25 mole %, based on 100 mole % polycarboxylic acid.

11. The polyol latex composition of claim 1, wherein the stabilizer comprises a sulfopolyester, present in an amount of from 0.1 to 10 weight % of the latex composition.

12. The polyol latex composition of claim 1, wherein the polyol comprises at least one member selected from the group consisting of glycerol, trimethylolethane, trimethylolpropane, pentaerythritol, sorbitol, 1,2,6-hexanetriol, 1,1,4,4-tetrakis(hydroxymethyl)cyclohexane, tris(hydroxyethyl) isocyanurate, tripentaerythritol, and dipentaerythritol.

13. The polyol latex composition of claim 1, wherein the monomer comprises at least one member selected from the group consisting of acetoacetoxy ethyl methacrylate, acetoacetoxy ethyl acrylate, methyl acrylate, methyl methacrylate, ethyl acrylate, ethyl methacrylate, butyl acrylate, butyl methacrylate, isobutyl acrylate, isobutyl methacrylate, ethylhexyl acrylate, 2-ethylhexyl methacrylate, 2-ethyl hexyl acrylate, isoprene, octyl acrylate, octyl methacrylate, iso-octyl acrylate, iso-octyl methacrylate, trimethyolpropyl triacrylate, styrene, (α-methyl styrene, glycidyl methacrylate, carbodiimide methacrylate, C₁-C₁₈ alkyl crotonates, di-n-butyl maleate, α- or β-vinyl naphthalene, di-octylmaleate, allyl methacrylate, di-allyl maleate, di-allylmalonate, methyoxybutenyl methacrylate, isobornyl methacrylate, hydroxybutenyl methacrylate, hydroxyethyl(meth)acrylate, hydroxypropyl(meth)acrylate, acrylonitrile, vinyl chloride, vinylidene chloride, vinyl acetate, vinyl ethylene carbonate, epoxy butene, 3,4-dihydroxybutene, hydroxyethyl(meth)acrylate, methacrylamide, acrylamide, butyl acrylamide, ethyl acrylamide, butadiene, vinyl(meth)acrylates, isopropenyl(meth)acrylate, cycloaliphaticepoxy(meth)acrylates, ethylformamide, 4-vinyl-1,3-dioxolan-2-one, 2,2-dimethyl-4 vinyl-1,3-dioxolate or 3,4-di-acetoxy-1-butene, acrylic acid, methacrylic acid, itaconic acid, crotonic acid, and monovinyl adipate.

14. The polyol latex composition of claim 1, wherein the monomer comprises at least one member selected from the group consisting of methyl (meth)acrylate, butyl acrylate, 2-ethyl hexyl acrylate, styrene, methacrylic acid, acrylic acid and hydroxyethyl (meth)acrylate.

15. The polyol latex composition of claim 1, wherein the latex polymer particles comprise a non-core shell latex.

16. The polyol latex composition of claim 1, wherein the latex polymer particles comprise a core shell latex.

17. A polyol latex composition, comprising:
a. latex polymer particles comprising a residue of an ethylenically unsaturated monomer;
b. a stabilizer comprising at least one of a surfactant and a sulfopolyester; and
c. a liquid continuous phase comprising a polyol component at from greater than 25% to 100 weight % of the continuous phase, wherein the continuous phase is essentially free of a diol component.

18. A process for preparing a polyol latex polymer composition, comprising the steps of:
a. preparing an emulsion comprising;
i) a monomer suitable for preparing latex polymer particles;
ii) an initiator;
iii) a stabilizer comprising at least one of a surfactant or a sulfopolyester; and
iv) a liquid continuous phase comprising a polyol component at from greater than 10% to 100 weight % of the continuous phase, wherein the continuous phase is essentially free of a diol component; and
b. heating the emulsion to polymerize the monomer, thereby forming a polyol latex polymer composition.

19. The process of claim 18, wherein the polyol component comprises from 40% to 100 weight % of the continuous phase.

20. The process of claim 18, wherein the polyol component comprises from 75% to 100 weight % of the continuous phase.

21. The process of claim 18, wherein the continuous phase consists essentially of the polyol component.

22. The process of claim 18, wherein the continuous phase comprises a water component.

23. The process of claim 18, wherein the stabilizer comprises a surfactant, present in an amount of from 0.1% to 10 weight % of the latex composition.

24. The process of claim 23, wherein the stabilizer comprises a surfactant selected from the group consisting of an anionic surfactant, a cationic surfactant, a nonionic surfactant, and mixtures thereof.

25. The process of claim 23, wherein the surfactant comprises at least one member selected from the group consisting of a polymerizable or nonpolymerizable alkyl ethoxylate sulfate, an alkyl phenol ethoxylate sulfate, an alkyl ethoxylate or an alkyl phenol ethoxylate.

26. The process of claim 18, wherein the stabilizer comprises a sulfopolyester, present in an amount of from 0.1% to 10% of the latex composition.

27. The process of claim 18, wherein the stabilizer comprises a sulfopolyester comprising a polycarboxylic acid, a diol and a difunctional sulfo-monomer.

28. The process of claim 27, wherein the difunctional sulfo-monomer comprises from 8 mole % to 25 mole %, based on 100 mole % polycarboxylic acid.

29. The process of claim 18, wherein the monomer comprises at least one member selected from the group consisting of acetoacetoxy ethyl methacrylate, acetoacetoxy ethyl acrylate, methyl acrylate, methyl methacrylate, ethyl acrylate, ethyl methacrylate, butyl acrylate, butyl methacrylate, isobutyl acrylate, isobutyl methacrylate, ethylhexyl acrylate, 2-ethylhexyl methacrylate, 2-ethyl hexyl acrylate, isoprene, octyl acrylate, octyl methacrylate, iso-octyl acrylate, iso-octyl methacrylate, trimethyolpropyl triacrylate, styrene, α-methyl styrene, glycidyl methacrylate, carbodiimide methacrylate, C₁-C₁₈ alkyl crotonates, di-n-butyl maleate, α- or β-vinyl naphthalene, di-octylmaleate, allyl methacrylate, di-allyl maleate, di-allylmalonate, methyoxybutenyl methacrylate, isobornyl methacrylate, hydroxybutenyl methacrylate, hydroxyethyl(meth)acrylate, hydroxypropyl(meth)acrylate, acrylonitrile, vinyl chloride, vinylidene chloride, vinyl acetate, vinyl ethylene carbonate, epoxy butene, 3,4-dihydroxybutene, hydroxyethyl(meth)acrylate, methacrylamide, acrylamide, butyl acrylamide, ethyl acrylamide, butadiene, vinyl(meth)acrylates, isopropenyl(meth)acrylate, cycloaliphaticepoxy(meth)acrylates, ethylformamide, 4-vinyl-1,3-dioxolan-2-one, 2,2-dimethyl-4 vinyl-1,3-dioxolate or 3,4-di-acetoxy-1-butene, acrylic acid, methacrylic acid, itaconic acid, crotonic acid and monovinyl adipate.

30. The process of claim 18, wherein the monomer comprises at least one member selected from the group consisting of methyl (meth)acrylate, butyl acrylate, 2-ethyl hexyl acrylate, styrene, methacrylic acid, acrylic acid, and hydroxyethyl (meth)acrylate.

31. The process of claim 18, wherein the polyol comprises at least one member selected from the group consisting of glycerol, trimethylolethane, trimethylolpropane, pentaerythritol, sorbitol, 1,2,6-hexanetriol, 1,1,4,4-tetrakis(hydroxymethyl)cyclohexane, tris(hydroxyethyl) isocyanurate, tripentaerythritol, and dipentaerythritol.

32. The process of claim 18, wherein the latex polymer particles comprise a non-core shell polymer.

33. The process of claim 18, wherein the latex polymer particles comprise a core shell latex.

34. A process for preparing a polyol latex polymer composition, comprising the steps of:
a. preparing an emulsion comprising;
i) a monomer suitable for preparing latex polymer particles;
ii) an initiator;
iii) a stabilizer comprising at least one of a surfactant and a sulfopolyester; and
iv) a liquid continuous phase comprising a polyol component at from greater than 25% to 100 weight % of the continuous phase, wherein the continuous phase is essentially free of a diol component; and
b. heating the emulsion to polymerize the monomer, thereby forming a polyol latex polymer composition.

35. A process for preparing a latex modified condensation polymer comprising the steps of:
a. preparing a polyol latex composition comprising:
i) latex polymer particles comprising a residue of an ethylenically unsaturated monomer;
ii) a stabilizer comprising at least one of a surfactant and a sulfopolyester; and
iii) a liquid continuous phase comprising a polyol component at from greater than 10% to 100 weight % of the continuous phase, wherein the continuous phase is essentially free of a diol component;
b. introducing the polyol latex composition into a condensation polymerization reaction mixture comprising at least one of a diacid, a di-isocyanate, a diakyl carbonate, a diaryl carbonate, and a dihalo carbonate, and at least one of a polyol component and a diol component, wherein the materials of steps a) and b) comprise a reaction mixture; and
c. polymerizing the reaction mixture, thereby forming latex modified condensation polymer.

36. The process of claim 35, wherein the polyol component of the polyol latex composition comprises from greater than 40% to 100 weight % of the continuous phase.

37. The process of claim 35, wherein the polyol component of the polyol latex composition comprises from greater than 75 to 100 weight % of the continuous phase.

38. The process of claim 35, wherein the continuous phase of the polyol latex composition consists essentially of the polyol component.

39. The process of claim 35, wherein the continuous phase of the polyol latex composition comprises a water component.

40. The process of claim 35, wherein the polyol comprises at least one of glycerol, trimethylolethane, trimethylolpropane, pentaerythritol, sorbitol, 1,2,6-hexanetriol, 1,1,4,4-tetrakis(hydroxymethyl)cyclohexane, tris(hydroxyethyl) isocyanurate, tripentaerythritol, and dipentaerythritol.

41. The process of claim 35, wherein the condensation polymerization reaction medium comprises a diol component.

42. The process of claim 35, wherein the condensation polymerization reaction medium comprises a polyol component.

43. The process of claim 35, wherein a diol component is present in step (b) and comprises at least one member selected from the group consisting of ethylene diol, 1,3-trimethylene diol, propylene diol, tripropylene diol, 1,4-butanediol, 1,5-pentanediol, 1,6 hexanediol, 1,7-heptanediol, 1,8-octanediol, 1,9-nonanediol, neopentyl diol, cis- or trans cyclohexanedimethanol, cis or trans 2,2,4,4-tetramethyl-1,3-cyclobutanediol, and diethylene diol.

44. The process of claim 35, wherein the stabilizer comprises a surfactant which is present in an amount of from 0.1% to 2 weight % of the latex composition.

45. The process of claim 35, wherein the stabilizer comprises a surfactant selected from the group consisting of a polymerizable or nonpolymerizable alkyl ethoxylate sulfate, alkyl phenol ethoxylate sulfate, alkyl ethoxylate, or alkyl phenol ethoxylate.

46. The process of claim 35, wherein the stabilizer comprises a sulfopolyester present in an amount of from 1 to 10 weight % of the latex composition.

47. The process of claim 35, wherein the stabilizer comprises a sulfopolyester comprised of residues of a polycarboxylic acid, a diol, and a difunctional sulfo-monomer.

48. The process of claim 35, wherein the latex polymer particles comprise a residue of at least one member selected from the group consisting of acetoacetoxy ethyl methacrylate, acetoacetoxy ethyl acrylate, methyl acrylate, methyl methacrylate, ethyl acrylate, ethyl methacrylate, butyl acrylate, butyl methacrylate, isobutyl acrylate, isobutyl methacrylate, ethylhexyl acrylate, 2-ethylhexyl methacrylate, 2-ethyl hexyl acrylate, isoprene, octyl acrylate, octyl methacrylate, iso-octyl acrylate, iso-octyl methacrylate, trimethyolpropyl triacrylate, styrene, α-methyl styrene, glycidyl methacrylate, carbodiimide methacrylate, C₁-C₁₈ alkyl crotonates, di-n-butyl maleate, α- or β-vinyl naphthalene, di-octylmaleate, allyl methacrylate, di-allyl maleate, di-allylmalonate, methyoxybutenyl methacrylate, isobornyl methacrylate, hydroxybutenyl methacrylate, hydroxyethyl(meth)acrylate, hydroxypropyl(meth)acrylate, acrylonitrile, vinyl chloride, vinylidene chloride, vinyl acetate, vinyl ethylene carbonate, epoxy butene, 3,4-dihydroxybutene, hydroxyethyl(meth)acrylate, methacrylamide, acrylamide, butyl acrylamide, ethyl acrylamide, butadiene, vinyl(meth)acrylates, isopropenyl(meth)acrylate, cycloaliphaticepoxy(meth)acrylates, ethylformamide, 4-vinyl-1,3-dioxolan-2-one, 2,2-dimethyl-4 vinyl-1,3-dioxolate, 3,4-di-acetoxy-1-butene, acrylic acid, methacrylic acid, itaconic acid, crotonic acid, and monovinyl adipate.

49. The process of claim 35, wherein the latex polymer particles comprise a non-core shell polymer.

50. The process of claim 35, wherein the latex polymer particles comprise a core shell polymer.

51. A thermoset composition, comprising,
a. the polyol latex composition of claim 1; and
b. a di- or multi-functional compound reactive toward hydroxyl groups present on the latex polymer particles.

52. The composition of claim 51, wherein the di- or multi-functional compound comprises an isocyanate or a blocked isocyanate.

53. The composition of claim 51, wherein the di- or multi-functional compound comprises at least one of a melamine-formaldehyde resin and a urea-formaldehyde resin.
